(19) United States
(12) Patent Application Publication
(10) Pub. No.: US 2013/0341131 A1
(43) Pub. Date: Dec. 26, 2013

(54) Electromechanical Vehicle Brake

(71) Applicant: Paul S. Friesen, Goshen, IN (US)

(72) Inventor: Paul S. Friesen, Goshen, IN (US)

(21) Appl. No.: 13/530,203

(22) Filed: Jun. 22, 2012

(51) Int. Cl. B60T 1/06

(52) U.S. Cl. 188/72.1

(57) ABSTRACT

An electromechanical vehicle brake comprising a brake disc, a caliper having a brake pad in frictional engagement with the brake disc, a coil frictionally engageable with the brake disc upon application of an electric current to the coil, the coil coupled to the caliper, and frictional engagement of the coil with the brake disc causes a clamp force to be applied by the caliper to the brake disc.

### FIELD OF THE INVENTION

The invention relates to an electromechanical vehicle brake, and more particularly, to an electromechanical vehicle brake comprising a magnetic member disposed to frictionally engage the brake disc upon application of an electric current to the magnetic member, and the magnetic member coupled to the caliper such that movement of the magnetic member upon frictional engagement with the brake disc actuates the caliper to impart a clamp force to the brake disc.

### BACKGROUND OF THE INVENTION

Conventional vehicle brake systems are typically either hydraulic or electromechanical. The hydraulic systems typically comprise a caliper engaging a brake disc on each wheel. The caliper clamps the brake disc by application of hydraulic pressure to a caliper piston. The hydraulic pressure is typically applied by movement of a piston in a master cylinder.

Electromechanical systems typically rely on electrical actuators such as solenoids. Energization of the solenoid causes a brake shoe to engage with the brake disc.

Representative of the art is U.S. Pat. No. 6,318,513 which discloses an electromechanical brake, in particular for vehicles, having an electric actuator which generates an actuation force and acts on at least one frictional element so as to press the latter, in order to bring about a frictional force, against a rotatable component of the brake which is to be braked. In order to keep the actuation force to be applied by the actuator low, there is, between the component to be braked and the electric actuator, an arrangement which brings about the self-energization of the actuation force generated by the electric actuator. In the event of a deviation between the setpoint value and the actual value, a device for comparing a setpoint value of the frictional force with the actual value of the frictional force controls the electric actuator, in order to correspondingly increase or decrease the generated actuation force, with the result that the actual value is approximated to the setpoint value of the frictional force. Fluctuations in the coefficient of friction thus do not have a disruptive effect.

What is needed is an electromechanical vehicle brake comprising a magnetic member disposed to frictionally engage the brake disc upon application of an electric current to the magnetic member, and the magnetic member coupled to the caliper such that movement of the magnetic member upon frictional engagement with the brake disc actuates the caliper to impart a clamp force to the brake disc. The present invention meets this need.

### SUMMARY OF THE INVENTION

The primary aspect of the invention is to provide an electromechanical vehicle brake comprising a magnetic member disposed to frictionally engage the brake disc upon application of an electric current to the magnetic member, and the magnetic member coupled to the caliper such that movement of the magnetic member upon frictional engagement with the brake disc actuates the caliper to impart a clamp force to the brake disc.

Other aspects of the invention will be pointed out or made obvious by the following description of the invention and the accompanying drawings.

The invention comprises an electromechanical vehicle brake comprising a brake disc, a caliper having a brake pad in frictional engagement with the brake disc, a coil frictionally engageable with the brake disc upon application of an electric current to the coil, the coil coupled to the caliper, and frictional engagement of the coil with the brake disc causes a clamp force to be applied by the caliper to the brake disc.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is an exploded perspective view of the device.

FIG. 2 is an exploded perspective view of the device.

FIG. 3 is side elevation exploded view of the device.

FIG. 4 is a side elevation view of the device.

FIG. 5 is a bottom perspective view of the device.

FIG. 6 is a side elevation view of the device.

FIG. 7 is a front elevation view of the device.

### DETAILED DESCRIPTION OF THE PREFERRED EMBODIMENT

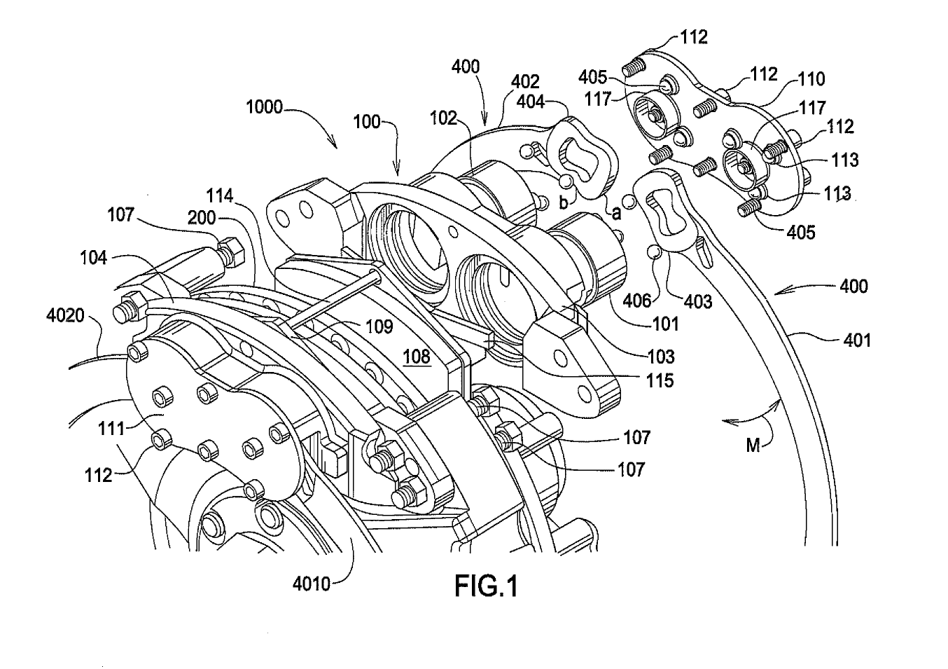

FIG. 1 is an exploded perspective view of the device. The device 1000 comprises a caliper assembly 100, a brake disc 200 and a magnetic member 300, 302 (see FIG. 5) and linkages 400.

The caliper assembly 100 comprises pistons 101 and 102. Pistons 101, 102 are disposed in a housing 103. An identical caliper arrangement 104 is on the opposite side of the brake disc from caliper housing 103. Pistons 105, 106 are disposed in housing 104. Housing 103 is fastened to housing 104 by fasteners 107.

Pistons 101, 102 bear upon a brake pad 108. The pistons are positioned rotationally with a key 115. Pistons 105, 106 bear upon a brake disc 109 and are locked with key 116 (not shown). Key 116 is identical in form and function to key 115. Brake pads 108, 109 are also held in place by a rod 114 which extends between the calipers.

Brake disc 200 is mounted to a vehicle axle or spindle (not shown) in a manner known in the art.

Magnetic member 300 and 302 frictionally engage the brake disc 200. Each magnetic member 300, 302 is disposed remote from each caliper on the brake disc 200, that is, each magnetic member is not co-located with a caliper. Magnetic member 300 and 302 are each coupled to the caliper 100 by linkages 401, 402 and 4010, 4020 respectively. Each linkage has an arcuate form so each can fit around the brake disc rotor hat 201.

Linkage head 403 and linkage head 404 are coupled to caliper 300 by plate 110 and pivot 117. Each linkage 401, 402 pivots (M) about each head 403, 404 respectively as is more fully described in FIG. 7. Plate 110 and pivot 117 are connected to the caliper housing 103 by fasteners 112. Plate 111 also comprises a pivot identical to pivot 117.

Each head 403 and 404 comprise an undulating form which in plan comprises an elevated (a) and recessed (b) portion. Each linkage 4010 and 4020 also comprises a head having an identical undulating form as described for head 403 and 404.

Plate 110 comprises a plate receiving portion 113. Each plate receiving portion 113 receives a spherical ball 405. Piston 101 comprises a piston receiving portion 101(a) to receive balls 406. Piston 102 comprises a piston receiving portion 102(a) to receive balls 406.

Each piston receiving portion 101(a) and 102(a) is disposed to cooperate with a corresponding linkage recessed portion 404(b) and 403(b) respectively whereby a ball 406 is captured between a piston receiving portion 102(a) and a linkage recessed portion (b).

The initial, non-activated brake position aligns all the balls 406 with the recessed portions (b) of head 403 and head 404. Each plate receiving portion 113 is disposed to cooperate with a corresponding linkage elevated portion 404(a) and 403(a) respectively whereby a ball 405 is captured between a plate receiving portion 113 and a linkage elevated portion (a). The arrangement described also applies to each piston 101, 102, 105, 106 and plate 110 and plate 111.

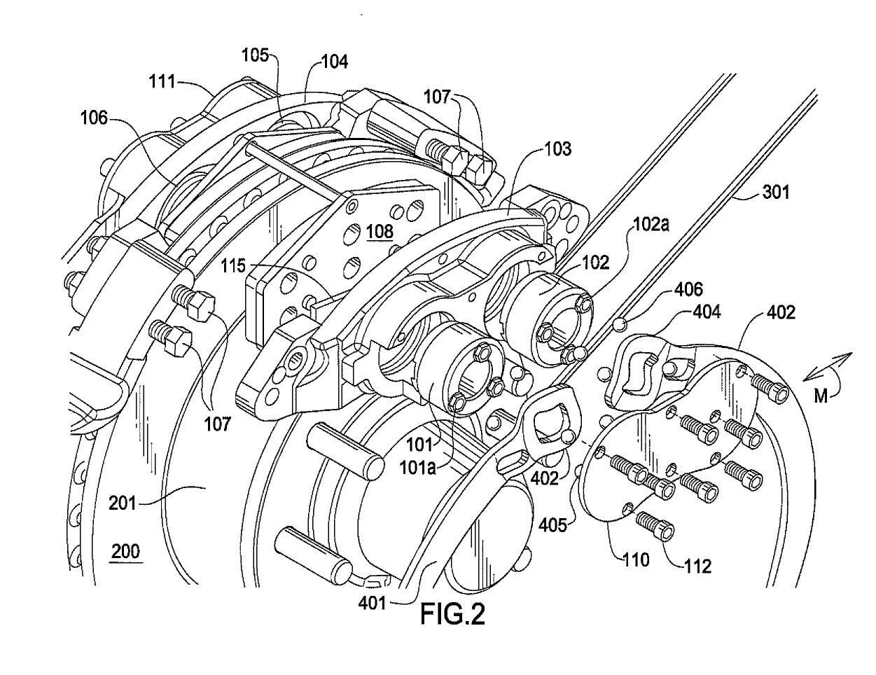

FIG. 2 is an exploded perspective view of the device. Receiving portions 102(a) are disposed upon piston 102. Receiving portions 101(a) are disposed upon piston 101. Each receiving portion 101(a) and 102(a) receives a ball 406.

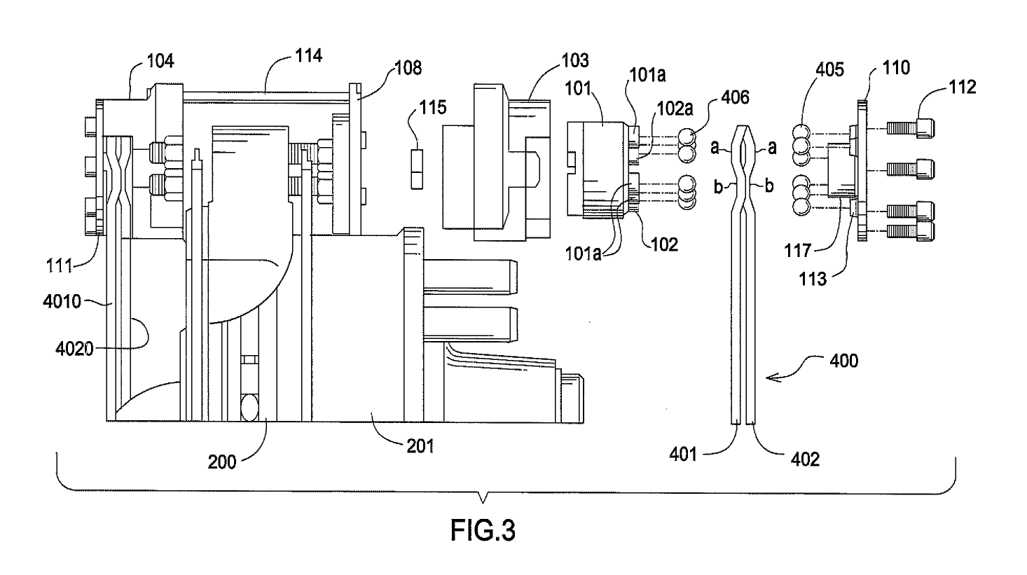

FIG. 3 is side elevation exploded view of the device. Linkage 401 is slightly horizontally offset from linkage 402 in order to minimize the width of the linkage pair. This reduces the space required for the system.

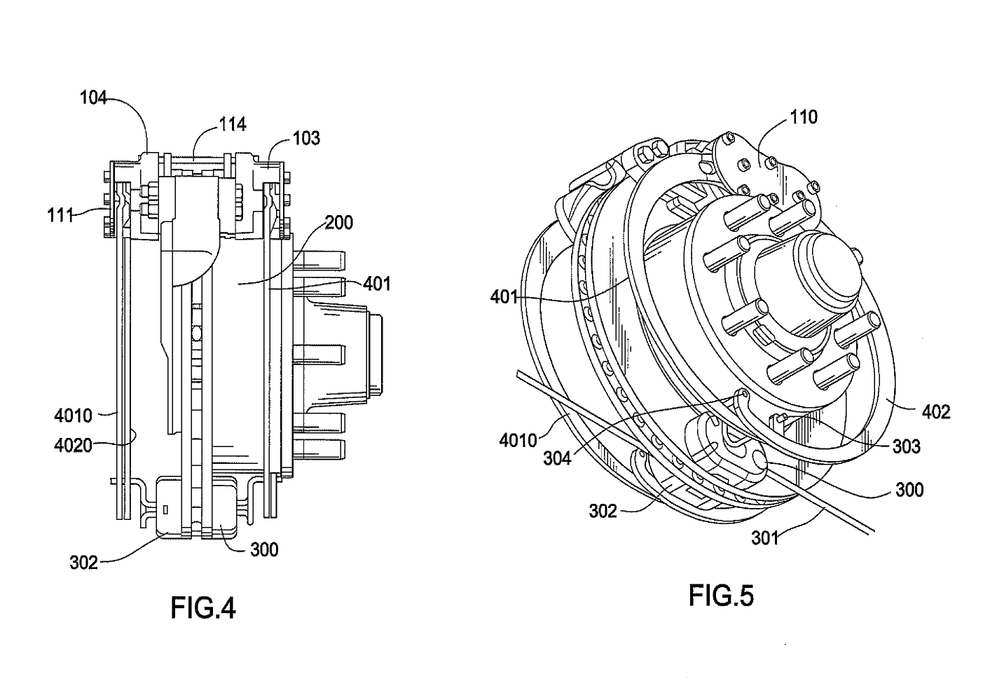

FIG. 4 is a side elevation view of the device. The system comprises a magnetic member 302 on the side opposite magnetic member 300. The arrangement of each side is substantially identical.

FIG. 5 is a bottom perspective view of the device. Each linkage 401 and 402 attaches to the magnetic member 300 at different locations 303 and 304 respectively. Each linkage head 403, 404 engages the caliper at different locations over each piston 101, 102. Connecting the linkages at different locations creates a parallelogram linkage of a kind whereby the magnetic member 300 is allowed to rotate slightly and in a controlled manner as it moves on the brake disc during a braking maneuver. This in turn keeps the magnetic member from protruding unnecessarily beyond the circumference of the brake disc as it moves.

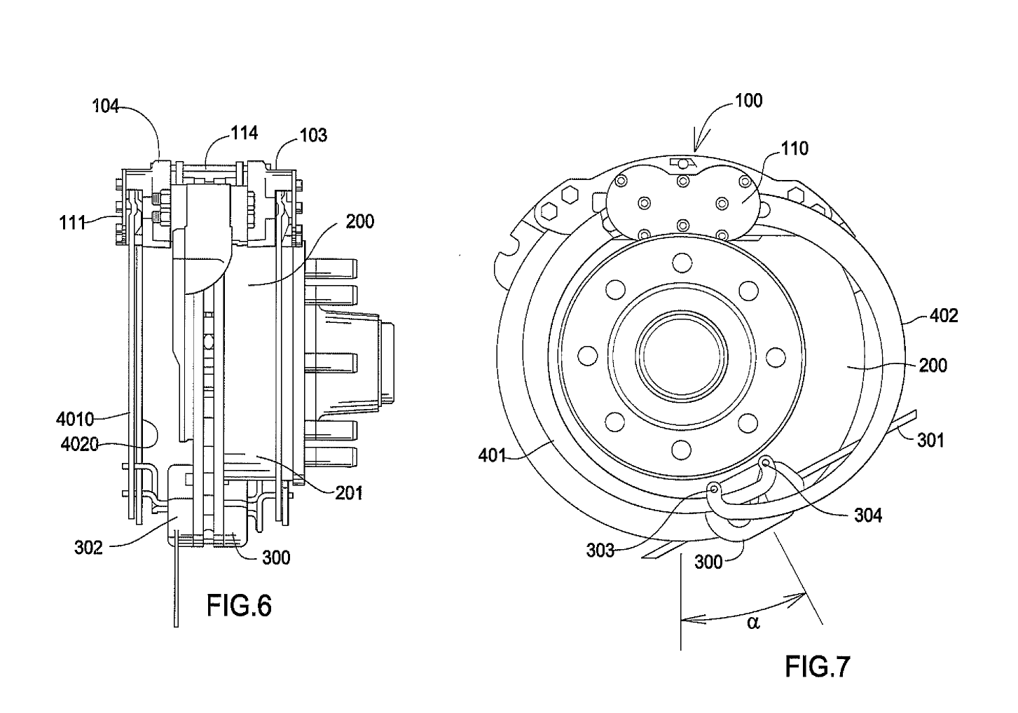

FIG. 6 is a side elevation view of the device. Magnetic members 300, 302 are preferably disposed opposite each other on the brake disc 200.

FIG. 7 is a front elevation view of the device. In operation an electric current is applied to the magnetic member 300 through a wire 301. The electric current is applied by and controlled by a vehicle braking system, for example linked to a vehicle ECU (not shown).

The magnetic member comprises a conductive coil. The electric current creates a magnetic field in the magnetic member so that it is magnetically attracted to the brake disc. Engagement with the rotating brake disc causes the magnetic member to move from the de-energized position which causes the linkages to partially rotate (M). The linkages 400 locate the magnetic member in position in relation to the brake disc. Put another way, upon frictional engagement of the magnetic member with the brake disc a clamp force is applied to the brake disc through an axial movement of each piston.

The frictional force is a function of the normal force exerted by the magnetic member on the brake disc. The normal force magnitude is a function of the amount of electric current in the coil. The electric current can be controlled and varied according to signals from a vehicle ECU (not shown).

The partial rotation of each linkage causes the recessed portion and elevated portion in each head 403, 404 to bear upon the balls 405, 406 which in turn causes an axial movement of each piston 101, 102. The axial movement of each piston 101, 102 applies a clamp force to the brake pad, thereby applying a frictional braking force to the brake disc. This explanation also applies to the second caliper 104 and magnetic member 302.

A sample calculation illustrates the operation.

$$Torque calculation \text{:}$$

$$Torque from linkage to caliper = Lever Arm \times Magnetic member force = 10 in \times 91 lbf = 910 in lbf$$

$$Ramp force at ball ramp radius = Lever torque / Ramp radius = 910 in lbf / 0.7 in = 1300 lbf$$

$$Ball ramp lift component \text{:} = Ramp force \times lift ratio = 1300 lbf \times 1.73 = 2249 lbf$$

This clamping force is applied to each respective piston 101, 102, 105, 106. Since there are four pistons in the two calipers the total clamp force for this example is 8,996 pounds. The inventive system achieves a high clamp force using a piston style caliper without the need for a hydraulic system.

The range of movement for each energized magnetic member 300, 302 is up to approximately α=30° from the non-energized position. The range of movement of the magnetic member is limited by the free travel available to each linkage when in the energized position.

Although a form of the invention have been described herein, it will be obvious to those skilled in the art that variations may be made in the construction and relation of parts without departing from the spirit and scope of the invention described herein.

I claim:

1. An electromechanical vehicle brake comprising:
a brake disc;
a caliper having a brake pad in frictional engagement with the brake disc;
a magnetic member disposed to frictionally engage the brake disc upon application of an electric current to the magnetic member; and
the magnetic member coupled to the caliper such that movement of the magnetic member upon frictional engagement with the brake disc actuates the caliper to impart a clamp force to the brake pad and thereby to the brake disc.

2. The electromechanical vehicle brake as in claim 1, wherein the magnetic member is coupled to the caliper by a linkage.

3. The electromechanical vehicle brake as in claim 2, wherein the linkage further comprises a head having undulations for applying a clamp force according to the position of the linkage relative to the caliper.

4. The electromechanical vehicle brake as in claim 3, wherein the magnetic member is coupled to the caliper by a second linkage, the second linkage comprises a head having undulations for applying a clamp force according to the position of the linkage relative to the caliper.

5. The electromechanical vehicle brake as in claim 4, wherein the magnetic member comprises a conductive coil.

6. An electromechanical vehicle brake comprising:
a brake disc;
a caliper having a brake pad in frictional engagement with the brake disc;
a coil frictionally engageable with the brake disc upon application of an electric current to the coil, the coil coupled to the caliper; and
frictional engagement of the coil with the brake disc causes a clamp force to be applied by the caliper to the brake disc.

7. The electromechanical vehicle brake as in claim 6, wherein the coil is coupled to the caliper by a linkage.

8. The electromechanical vehicle brake as in claim 7, wherein the linkage further comprises a head having undulations for applying a variable clamp force according to the position of the linkage relative to the caliper.

9. The electromechanical vehicle brake as in claim 7, wherein the coil is coupled to the caliper by a second linkage, the second linkage comprises a head having undulations for applying a variable clamp force according to the position of the linkage relative to the caliper.

10. An electromechanical vehicle brake comprising:
a brake disc;
a caliper disposed to frictionally engage the brake disc;
a magnetic member frictionally engageable with the brake disc upon application of an electric current to the magnetic member; and
the magnetic member coupled to the caliper, whereby a clamp force is applied by the caliper to the brake disc upon movement of the magnetic member.
